(19) United States
(12) Patent Application Publication
(10) Pub. No.: US 2025/0033041 A1
(43) Pub. Date: Jan. 30, 2025

(54) REAGENT PRE-EMBEDDING AND SAMPLE INJECTING DEVICE, AND SAMPLE INJECTION METHOD THEREFOR AND APPLICATION THEREOF

(71) Applicant: JIANGSU LOGILET BIOTECH CO., LTD., Suzhou (CN)

(72) Inventors: Qiuping WANG, Suzhou (CN); Yang SU, Suzhou (CN); Yan ZHANG, Suzhou (CN)

(21) Appl. No.: 18/711,039

(22) PCT Filed: Aug. 19, 2022
(86) PCT No.: PCT/CN2022/113745

§ 371 Date: May 16, 2024

(30) Foreign Application Priority Data
Nov. 18, 2021 (CN) 202111367096.1

(51) Int. Cl. B01L 3/00

(52) U.S. Cl. CPC B01L 3/502715; B01L 3/502784; B01L 3/523; B01L 3/527; B01L 2200/06; B01L 2300/044; B01L 2300/0672

(57) ABSTRACT

A reagent pre-embedding and sample injecting device, and a sample injection method therefor and application thereof. The reagent pre-embedding and sample injecting device comprises a reagent container for sealing and storing a reagent, and a sample injection seat. The sample injection seat has a cavity structure, a bottom liquid-outputting end, and a liquid injection column. The reagent container is arranged at a top open end of the cavity structure. The bottom liquid-outputting end is used for extending into a gap cavity of a digital micro-fluidic chip. The liquid injection column is arranged at the bottom of the cavity structure, and the end of the liquid injection column is provided with a puncturing component for puncturing the reagent container, such that the reagent in the reagent container flows into the gap cavity of the digital micro-fluidic chip from the bottom liquid-outputting end of the sample injection seat.

### TECHNICAL FIELD

The present disclosure belongs to the technical field of microfluidic chips and relates to a reagent pre-embedding and sample injecting device, and a sample injection method therefor and an application thereof.

### BACKGROUND ART

A microfluidic chip integrates basic operating units, which are configured for sample preparation, reaction, separation, test and the like in biological, chemical and medical analysis processes, into a chip having a micro-scale structure. The chip uses the principle of electrowetting technology, regulates solid-liquid surface energy by means of electric potential, and drives a liquid to move by virtue of the surface energy imbalance, so as to achieve precise control on micro-liquid.

During the liquid injection in the microfluidic chip, an operator typically needs to suck a certain amount of liquid sample by using a pipette, align the pipette with a sample inlet to completely inject the liquid into a reaction cavity. However, the use of a pipette to inject a sample increases use costs, and has high requirements on the operator's operating accuracy.

CN209406357U discloses a microfluidic chip that facilitates liquid injection. The microfluidic chip comprises a substrate and a cover plate. The substrate is provided with a plurality of microfluidic channels, the substrate and the cover plate are bonded into a whole, and the microfluidic channels are located between the substrate and the cover plate. The microfluidic chip further comprises a connecting conduit, the cover plate is provided with at least one guide hole, the guide hole is in communication with the microfluidic channels, and the connecting conduit is detachably connected into the guide hole at one end.

CN204583216U discloses a microfluidic chip realizing self-propelled movement of microfluids, comprising a chip substrate and a cover plate. The chip substrate is provided with a microfluidic channel having a V-shaped cross-section, the depth of an inlet of the microfluidic channel is between 10-800 micrometers, and the depth of an outlet of the microfluidic channel is between 20-800 micrometers. Moreover, the depth of the microfluidic channel gradually increases from the inlet to the outlet with a change rule being ΔH=ΔLtanβ, where ΔH is a channel depth increment, ΔL is a channel length increment, and 0<β<10 degrees.

CN108148752A discloses an integrated drug screening and staining method based on a microfluidic chip. The microfluidic chip is composed of a liquid path control layer as an upper layer, a gas path control layer as a lower layer, and a blank glass base plate as a bottom layer. The integrated drug screening and staining method based on a microfluidic chip sequentially comprises steps of: chip pre-treatment; cell inoculation and culture; drug stimulation; and fluorescent staining. An inlet of each liquid path layer is separately controlled by a valve of a gas path layer, and culture of different types of cells, stimulation with different drugs and staining with different antibodies can be simultaneously implemented. This invention achieves drug screening and fluorescent staining on the microfluidic chip by utilizing microfluidic and micro-valve technology in the microfluidic chip, so that a completely new technology platform is provided for researches on cell culture, cell in-situ fluorescent staining and drug screening. This method is simple and convenient to operate, uses less cells and reagents, and has a high integration level and a wide range of applications.

### SUMMARY

According to a first aspect of an embodiment of the present disclosure, a reagent pre-embedding and sample injecting device is provided. The reagent pre-embedding and sample injecting device comprises: a reagent container configured for sealing and storing a reagent, and a sample injection seat. The sample injection seat has a cavity structure, the reagent container being arranged at a top open end of the cavity structure; a bottom outlet end configured to extend into a gap cavity of a digital microfluidic chip; and a liquid injection column, arranged at the bottom of the cavity structure. A piercing component is provided at one end of the liquid injection column close to the reagent container and configured for piercing the reagent container to allow the reagent in the reagent container to flow into the gap cavity of the digital microfluidic chip from the bottom outlet end of the sample injection seat.

According to a second aspect of an embodiment of the present disclosure, a sample injection method for a reagent pre-embedding and sample injecting device according to the first aspect is provided. The sample injection method includes: pressing a reagent container such that a piercing component pierces the reagent container, and a reagent in the reagent container flows into a gap cavity of a digital microfluidic chip from a bottom outlet end of a sample injection seat.

According to a third aspect of an embodiment of the present disclosure, an application of a reagent pre-embedding and sample injecting device according to the first aspect is provided. The reagent pre-embedding and sample injecting device is used in the field of digital microfluidic chips.

According to the embodiments of the present disclosure, the reagent pre-embedding and sample injecting device is mainly used for the digital microfluidic chip, the reagent and other substances (relevant liquids, solids, or solid-liquid mixtures, etc.) required for testing are sealed and stored in the reagent container in advance, and the reagent container is pre-embedded in the sample injection seat, which can effectively prevent inconvenience and waste due to failures and the like caused by human errors in operation.

### BRIEF DESCRIPTION OF THE DRAWINGS

Embodiments of the present disclosure and features and advantages thereof will be described in detail below with reference to the accompanying drawings. In the figures:

FIG. 1 shows a schematic structural diagram of a reagent pre-embedding and sample injecting device according to some embodiments of the present disclosure;

FIG. 2 shows a schematic structural diagram of a reagent container according to some embodiments of the present disclosure;

FIGS. 3A and 3B show schematic structural diagrams of a reagent container as viewed from top and as viewed from bottom, respectively, according to some other embodiments of the present disclosure;

FIGS. 4A and 4B show schematic flowcharts of a sample injection method according to some embodiments of the present disclosure; and

FIGS. 5A and 5B show schematic flowcharts of a sample injection method according to some other embodiments of the present disclosure.

In the figures: 1—sample injection seat; 11—cavity structure; 12—bottom outlet end; 13—liquid injection column; 131—recess; 15—liquid injection hole; 2—reagent container; 21—reagent cavity; 22—outer wall; 23—recessed portion; 24—notch; 23′—recessed portion; 231′—protrusion; 232′—groove; 3—thin film; 4—hook structure; 5—reinforcing member; 6—piercing component; 61—tip of piercing component; 49—through hole; 59—through hole; 7—sealing film; 10—gap cavity.

In the figures, the same or similar elements are denoted by the same reference signs.

### DETAILED DESCRIPTION OF EMBODIMENTS

It should be understood that, in the description of the present disclosure, orientation or position relationships indicated by terms such as “center”, “longitudinal”, “transverse”, “up”, “down”, “front”, “rear”, “left”, “right”, “vertical”, “horizontal”, “top”, “bottom”, “inside”, and “outside” are based on orientation or position relationships shown in the accompanying drawings and are merely for ease of description of the present disclosure and simplification of the description, rather than indicating or implying that the apparatuses or elements referred to must have a specific orientation or be constructed and operated in a specific orientation, and therefore cannot be construed as limiting the present disclosure. In addition, the terms such as “first” and “second” are used for descriptive purposes only, and cannot be construed as indicating or implying relative importance or implicitly indicating the number of technical features indicated. Thus, the features defined with “first”, “second” and so on may explicitly or implicitly include one or more features. In the description of the present disclosure, “a plurality of” means two or more, unless otherwise specified.

It should be noted that in the description of the present disclosure, unless otherwise explicitly specified and defined, the terms “arranged”, “connected” and “connect” should be understood in a broad sense, for example, they may be a fixed connection, a detachable connection, or an integrated connection; may be a mechanical connection or an electrical connection; or may be a direct connection, an indirect connection by means of an intermediary, or internal communication between two elements. For those of ordinary skill in the art, the specific meanings of the terms mentioned above in the present disclosure should be construed according to specific circumstances.

Digital microfluidic chips can integrate operation processes, such as sampling, dilution, reagent addition, reaction, separation, and detection, that are usually required in the biological, chemical, medical and other fields. Compared with conventional control means, this technology can allow for less sample consumption, also has the advantages of high sensitivity, high precision, high throughput, high integration and the like, can quickly implement the entire automatic integrated process of biochemical reactions with lower costs and allow the entire process reaction to be performed in fully enclosed environment and free of cross contaminations, and can be operated with one button, thereby greatly freeing an operator's hands.

According to a first aspect of an embodiment of the present disclosure, a reagent pre-embedding and sample injecting device is provided. The technical solutions of the embodiments of the present disclosure will be described below with reference to the accompanying drawings and specific embodiments.

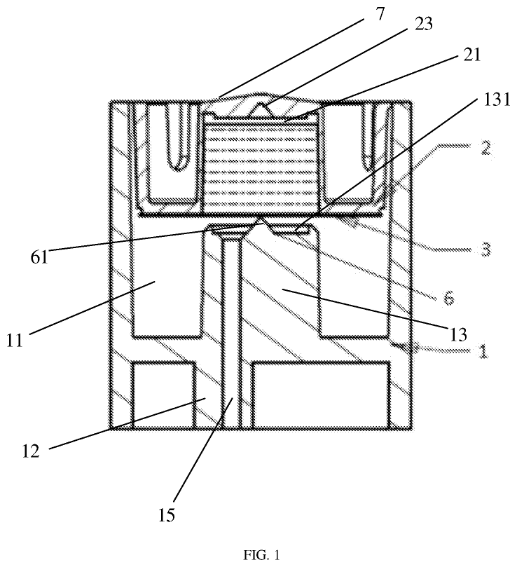

FIG. 1 shows a schematic structural diagram of a reagent pre-embedding and sample injecting device according to some embodiments of the present disclosure.

In some embodiments, as shown in FIG. 1, the reagent pre-embedding and sample injecting device comprises a sample injection seat 1 and a reagent container 2. The reagent container 2 is configured for sealing and storing a reagent in advance. The sample injection seat 1 has a cavity structure 11, a bottom outlet end 12, and a liquid injection column 13. The reagent container 2 is arranged at a top open end of the cavity structure 11. The bottom outlet end 12 is configured to extend into a gap cavity of a digital microfluidic chip. The liquid injection column 13 is arranged at the bottom of the cavity structure 11. A piercing component 6 is provided at an end of the liquid injection column 13 close to the reagent container 2. The piercing component 6 is configured for piercing the reagent container 2 to allow the reagent in the reagent container 2 to flow into the gap cavity of the digital microfluidic chip from the bottom outlet end of the sample injection seat.

The reagent pre-embedding and sample injecting device provided in the embodiments of the present disclosure is mainly used in the digital microfluidic chip. The reagent and other substances (relevant liquids, solids, or solid-liquid mixtures, etc.) required for testing are sealed and stored in the reagent container 2 in advance, the reagent container 2 is pre-embedded in the sample injection seat 1, and the reagent and other substances may be sealed and stored integrally with the digital microfluidic chip, which can effectively prevent inconvenience and waste due to failures and the like caused by human errors in operation.

It should be noted that those skilled in the art may, according to the above design principle, pre-embed an oil pocket on the digital microfluidic chip to carry out automatic oil injection.

In the embodiment as shown in FIG. 1, the piercing component 6 is in the form of a spike. In addition, it may be understood by those skilled in the art that the piercing component 6 may be a separate spiked structure, or another structure that can pierce the reagent container 2. The present disclosure does not make specific requirements for the structural form of the piercing component 6. The piercing component 6 may be fixed to the sample injection seat 1 by other connectors or integrated with the sample injection seat 1.

In some embodiments, as shown in FIG. 1, the reagent container 2 has a thin film 3, and the thin film 3 is arranged at the bottom of the reagent container 2 and used for sealing a reagent cavity 21 of the reagent container, the reagent cavity being configured for holding the reagent. The thin film, for example, fits to a surface of the reagent container 2, such as a bottom surface of the reagent container or the bottom surface and at least part of a circumferential surface of the reagent container. The thin film 3 may be a rigid film such as an aluminum film, or may be a thin film with a great elasticity, which is not easy to be pierced by the spiked structure 6, thereby preventing the thin film 3 from being accidentally pierced during transportation or storage.

In some embodiments, a sealing film 7 is provided at a top opening of the sample injection seat 1, and the sealing film 7 covers the reagent container 2 pre-embedded in the sample injection seat 1, and closely fits to the reagent container 2. By means of the sealing film 7, the reagent container 2 is kept in the sample injection seat 1, and the thin film 3 that seals the reagent cavity 21 is prevented from being pierced due to misoperation or other external forces applied to the reagent container 2. The sealing film 7 may, for example, be fixed to the top opening of the sample injection seat 1 by hot-melting or gluing. For example, the sealing film 7 may be subjected to a heat packaging treatment so that the sealing film 7 fits to the surface of the reagent container 2.

In some embodiments, the sample injection seat 1 is assembled on the digital microfluidic chip, the quantitatively packaged reagent container 2 is placed in the sample injection seat 1, the sealing film 7 is fixed to the top opening of the sample injection seat 1 by hot-melting or gluing, or the like, and the fixed sealing film 7 fits to the surface of the reagent container 2 through a heat packaging treatment.

The sealing film 7 may or may not be elastic. Before being pressed down, the reagent container 2 is bulging and the sealing film 7 bulges accordingly. After being pressed down, the reagent container 2 is pierced and the sealing film 7 is recessed by pressing.

In some embodiments, the reagent pre-embedding and sample injecting device further comprises a pressing device (not shown in the figures), and the pressing device is located above the sample injection seat 1 and used for continuously pressing the reagent container 2 during a sample injection process. It should be noted that the pressing device pushes the sealing film 7, and if the sealing film 7 has a good elasticity, the sealing film 7 will not break after it is deformed by pressing. If the sealing film 7 springs back after the pressing device is raised, the pressing device needs to press the sealing film 7 down throughout the whole process of liquid injection. If the sealing film 7 does not spring back after the pressing device is raised and maintains a recessed form, the pressing device may be raised and reset after one pressing.

In some embodiments, the sample injection seat 1 comprises a holding section and a piercing section, the holding section and the piercing section may, for example, be molded integrally, the reagent container 2 is located within the holding section, and the piercing component 6 is located within the piercing section.

In some embodiments, a liquid injection hole 15 is provided at the bottom of the sample injection seat 1 (e.g., the bottom outlet end 12), and an outlet end of the liquid injection hole 15 extends into the gap cavity of the digital microfluidic chip. The liquid injection hole 15 extends from the bottom of the sample injection seat 1 and through the liquid injection column 13 and leads to a top surface of the liquid injection column 13, and the liquid injection hole 15 is arranged next to the piercing component 6. The liquid injection hole 15 may be vertical or slant.

In some embodiments, the reagent container 2 has a reagent cavity 21 that is configured for holding the reagent; the reagent cavity 21 is aligned with the liquid injection column 13, and an inner wall of the reagent cavity 21 is in seal fit with an outer wall of the liquid injection column 13 when the reagent container 2 is pressed down until at least part of the liquid injection column 13 is located in the reagent cavity 21.

In some embodiments, a recess 131 is provided at the top of the liquid injection column 13 and configured for holding the reagent that flows from the reagent container 2 when the piercing component 6 pierces the reagent container 2, and preventing the reagent from flowing directly into the cavity structure 11 of the sample injection seat 1 when the reagent container has been pierced and the liquid injection column has not yet blocked the reagent cavity 21.

In some embodiments, a recessed portion 23 is provided at the bottom of the reagent cavity 21, and the recessed portion 23 is configured for accommodating a tip 61 of the piercing component 6. In this way, when the reagent container 2 is pressed down to a limit position, the top of the liquid injection column 6 may be in flat contact with the bottom of the reagent cavity 21. In addition, the recessed portion 23 may fit perfectly with the piercing component 6, so that all the reagent in the reagent container is pressed into the digital microfluidic chip through the liquid injection hole 15.

The process of the reagent flowing into the digital microfluidic chip is described in combination with the reagent pre-embedding and sample injecting device shown in FIG. 1. During the sample injection process, the reagent container 2 is pressed down; when the piercing component 6 pierces the reagent container 2, the reagent flowing out of the reagent container 2 first flows into the recess 131, thereby preventing the reagent from flowing directly into the cavity structure of the sample injection seat 1; when the reagent container 2 continues to be pressed down, the liquid injection column 13 fits into the reagent cavity of the reagent container 2 that holds the reagent, an outer wall of the liquid injection column 13 is in seal fit with an inner wall of the reagent cavity, and the reagent flows from the liquid injection hole 15 into the gap cavity of the digital microfluidic chip. Thus, overflowing of the reagent is avoided, and all the reagent can flow into the gap cavity of the digital microfluidic chip through the liquid injection hole 15.

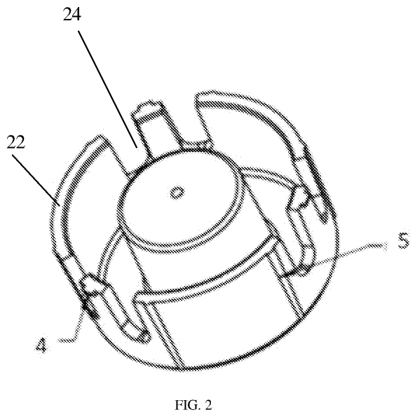

FIG. 2 shows a schematic structural diagram of a reagent container according to some embodiments of the present disclosure.

In some embodiments, for example, in the embodiments shown in FIG. 2, the reagent container 2 has the reagent cavity 21 that is configured for holding the reagent (as shown in FIG. 1) and an outer wall 22 surrounding the reagent cavity and spaced apart from the reagent cavity. The reagent container 2 is provided with a hook structure 4 for fixing the reagent container 2. Preferably, the reagent container 2 is also provided with reinforcing members 5.

As shown in FIG. 2, the outer wall 22 is provided with at least one hook structure 4 for fixing the reagent container 2 to the top opening of the sample injection seat 1, and, for example, the bottom of the reagent container 2 is spaced apart from the piercing component 6 by a distance. Thus, during transportation of the chip, the thin film 3 is less prone to being pierced accidentally by the piercing component 6 in advance due to bumps or the like.

Preferably, the outer wall 22 is provided with notches 24 on two sides of each hook structure 4, respectively. When the reagent container is pressed down, the hook structure 4 may be bent inwardly due to the notches on the sides, so that the reagent container can be easily pressed down.

Preferably, the outer wall 22 is provided with reinforcing members 5. As shown in FIG. 2, the reinforcing members 5 are respectively arranged on at least one side of each notch 24 in an extension direction of the notch 24. The reinforcing members may enhance the strength of the outer wall 22, in particular, the strength weakened due to the arrangement of the notches.

In some embodiments, the reagent container 2 is made of, for example, a polypropylene material by injection molding, which has a rigid structure and is less prone to deformation. The reagent cavity of the reagent container 2 may have a fixed volume, and may be configured for holding a quantitative volume of reagent. Therefore, the reagent and other substances (relevant liquids, solids, or solid-liquid mixtures, etc.) required for testing may be quantitatively sealed and stored in the reagent container 2 in advance.

In some embodiments, the volume of the reagent container 2 is 50 to 100 μL, for example, it may be 50 μL, 60 μL, 70 μL, 80 μL, 90 μL, and 100 μL, but it is not limited to the enumerated values, and other unenumerated values within the range of the values are also applicable. A reagent with a fixed volume may be packaged into the reagent container 2 according to the actual needs. The reagent pre-embedding and sample injecting device provided in the embodiments of the present disclosure may satisfy the liquid storage needs of different systems within a certain system range by adjusting the size of the reagent container 2.

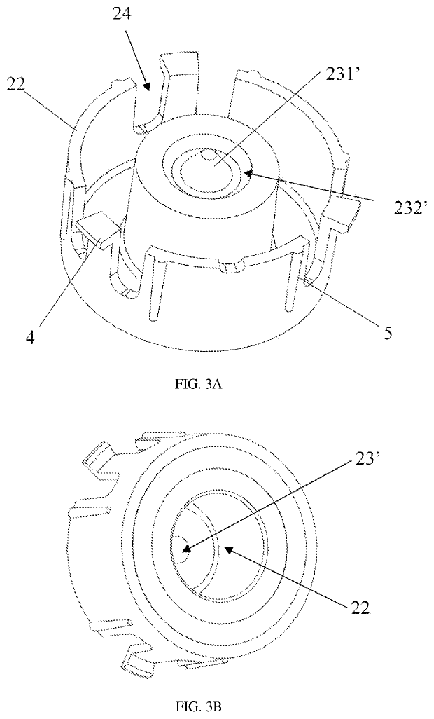

FIGS. 3A and 3B show schematic structural diagrams of a reagent container as viewed from top and as viewed from bottom, respectively, according to some other embodiments of the present disclosure. In the embodiments as shown in FIGS. 3A and 3B, a recessed portion 23′ is provided at the bottom of the reagent cavity 21, and the recessed portion 23′ is configured for accommodating a tip of a piercing component. On the other side of the bottom of the reagent cavity 21 opposite the recessed portion 23′, a protrusion 231′ corresponding to the recessed portion 23′ is provided, and a groove 232′ is provided surrounding the protrusion 231′.

According to another aspect of an embodiment of the present disclosure, a sample injection method for a reagent pre-embedding and sample injecting device is provided. The sample injection method includes: pressing a reagent container 2 such that a piercing component 6 pierces the reagent container 2, and a reagent in the reagent container 2 flows into a gap cavity of a digital microfluidic chip from a bottom outlet end (e.g., a liquid injection hole) of a sample injection seat 1. A pressing device may be used to automatically press the reagent container 2 in the process of pressing the reagent container 2, for example. In the sample injection method for the reagent pre-embedding and sample injecting device according to the embodiments of the present disclosure, there is no need for a user to manually operate during the sample injection process, which can effectively prevent the inconvenience and waste due to failures and the like caused by human errors in operation.

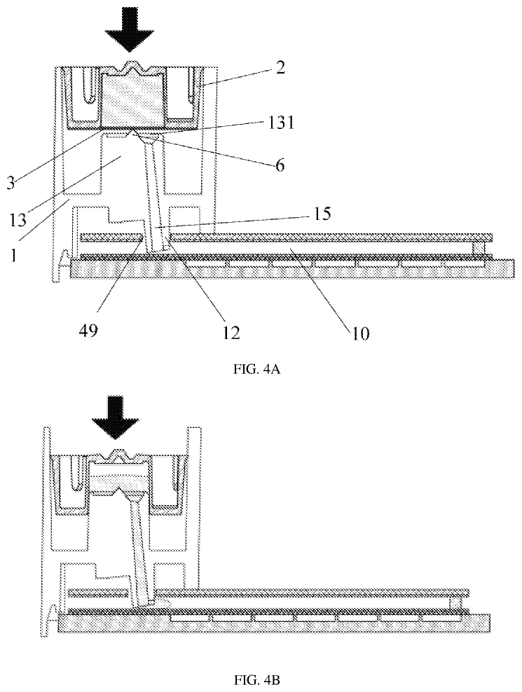

FIGS. 4A and 4B show schematic flowcharts of a sample injection method according to some embodiments of the present disclosure, where the direction of the arrow represents the direction of a downward pressure.

In some embodiments, as illustrated in FIGS. 4A and 4B, the bottom outlet end 12 of the sample injection seat 1 may extend into a gap cavity 10 of the digital microfluidic chip via a through hole 49 provided in the upper portion of the digital microfluidic chip.

As shown in FIG. 4A, the reagent container 2 is pressed down, and when the piercing component 6 pierces the thin film 3, the reagent in the reagent container first flows into the recess 131 on the top of the liquid injection column 13. As shown in FIG. 4B, as the reagent container 2 continues to be pressed down, an inner wall of the reagent container 2 closely fits with an outer wall of the liquid injection column 13, allowing the reagent to flow to the liquid injection hole 15. The reagent flows into the gap cavity 10 of the digital microfluidic chip through the liquid injection hole 15.

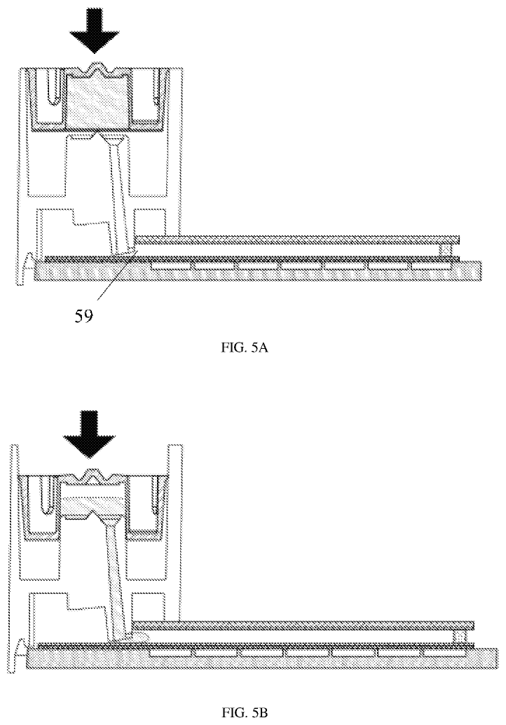

FIGS. 5A and 5B show schematic flowcharts of a sample injection method according to some other embodiments of the present disclosure, where the direction of the arrow represents the direction of a downward pressure. For clarity, reference signs for the same elements in FIGS. 5A and 5B as in FIGS. 4A and 4B are omitted.

In some embodiments, as illustrated in FIGS. 5A and 5B, a bottom outlet end of the sample injection seat may extend into the gap cavity of the digital microfluidic chip via a through hole 59 provided at one side of the digital microfluidic chip.

As shown in FIG. 5A, the reagent container is pressed down, and when the piercing component pierces the thin film, the reagent in the reagent container first flows into the recess on the top of the liquid injection column. As shown in FIG. 5B, as the reagent container continues to be pressed down, the inner wall of the reagent container closely fits with the outer wall of the liquid injection column, so that the reagent flows to the liquid injection hole, and is injected into the chip from the outlet end via the through hole 59 provided at one side of the chip.

According to another aspect of an embodiment of the present disclosure, an application of a reagent pre-embedding and sample injecting device according to any one of the foregoing embodiments is provided, where the reagent pre-embedding and sample injecting device is used in the field of digital microfluidic chips.

The applicant declared that the descriptions are merely specific implementations of the present disclosure, but are not intended to limit the scope of protection of the present disclosure; it should be obvious to those skilled in the art that any variation or replacement readily figured out by those skilled in the art within the technical scope disclosed in the present invention shall fall within the scope of protection and disclosure of the present disclosure.

1. A reagent pre-embedding and sample injecting device, comprising:
a reagent container for sealing and storing a reagent in advance; and
a sample injection seat having:
a cavity structure, the reagent container being arranged at a top open end of the cavity structure;
a bottom outlet end configured to extend into a gap cavity of a digital microfluidic chip; and
a liquid injection column arranged at the bottom of the cavity structure, wherein a piercing component is provided at an end of the liquid injection column close to the reagent container and configured for piercing the reagent container to allow the reagent in the reagent container to flow into the gap cavity of the digital microfluidic chip from the bottom outlet end of the sample injection seat.

2. The reagent pre-embedding and sample injecting device according to claim 1, wherein the reagent container has a thin film, and the thin film is arranged at the bottom of the reagent container and used for sealing a reagent cavity of the reagent container, the reagent cavity being configured for holding the reagent.

3. The reagent pre-embedding and sample injecting device according to claim 1, wherein a sealing film is provided at a top opening of the sample injection seat, and the sealing film closely fits to the reagent container; wherein
the sealing film is fixed to the top opening of the sample injection seat by hot-melting or gluing; and/or
the sealing film fits to a surface of the reagent container by means of heat packaging treatment.

4. The reagent pre-embedding and sample injecting device according to claim 1, wherein the sample injection seat comprises a holding section and a piercing section, the holding section and the piercing section are molded integrally, the reagent container is located within the holding section, and the piercing component is located within the piercing section.

5. The reagent pre-embedding and sample injecting device according to claim 1, wherein a liquid injection hole is provided at the bottom of the sample injection seat, and an outlet end of the liquid injection hole extends into the gap cavity of the digital microfluidic chip.

6. The reagent pre-embedding and sample injecting device according to claim 1, wherein the reagent pre-embedding and sample injecting device further comprises a pressing device, and the pressing device is located above the sample injection seat and used for continuously pressing the reagent container during sample injection.

7. The reagent pre-embedding and sample injecting device according to claim 1, wherein the reagent container has a volume of 50-100 μL.

8. The reagent pre-embedding and sample injecting device according to claim 1, wherein the reagent container is provided with a hook structure for fixing the reagent container.

9. The reagent pre-embedding and sample injecting device according to claim 1, wherein the reagent container is made of a polypropylene material by means of injection molding.

10. The reagent pre-embedding and sample injecting device according to claim 1, wherein the reagent container has a reagent cavity for holding the reagent and an outer wall surrounding the reagent cavity and spaced apart from the reagent cavity.

11. The reagent pre-embedding and sample injecting device according to claim 10, wherein the reagent cavity is aligned with the liquid injection column, and an inner wall of the reagent cavity is in seal fit with an outer wall of the liquid injection column when the reagent container is pressed down until at least part of the liquid injection column is located in the reagent cavity.

12. The reagent pre-embedding and sample injecting device according to claim 10, wherein a recessed portion is provided at the bottom of the reagent cavity, and the recessed portion is configured for accommodating a tip of the piercing component.

13. The reagent pre-embedding and sample injecting device according to claim 10, wherein the outer wall is provided with at least one hook structure, and the hook structure is configured for fixing the reagent container to the top opening of the sample injection seat.

14. The reagent pre-embedding and sample injecting device according to claim 1, wherein a recess is provided on the top of the liquid injection column and configured for holding the reagent that flows from the reagent container when the piercing component pierces the reagent container.

15. The reagent pre-embedding and sample injecting device according to claim 5, wherein the liquid injection hole extends from the bottom of the sample injection seat and through the liquid injection column and leads to a top surface of the sample injection column, and the liquid injection hole is arranged next to the piercing component.

16. A sample injection method for a reagent pre-embedding and sample injecting device according to claim 1, the method comprising:
pressing a reagent container such that a piercing component pierces the reagent container and a reagent in the reagent container flows into a gap cavity of a digital microfluidic chip from a bottom outlet end of a sample injection seat.

17. The sample injection method for the reagent pre-embedding and sample injecting device according to claim 16, wherein a pressing device is used in the process of pressing the reagent container so as to automatically press the reagent container.

18. The application of a reagent pre-embedding and sample injecting device according to claim 1, wherein the reagent pre-embedding and sample injecting device is used in the field of digital microfluidic chips.

19. The reagent pre-embedding and sample injecting device according to claim 8, wherein:
the reagent container is fixed to the top opening of the sample injection seat by the hook structure, and the bottom of the reagent container is spaced apart from the piercing component by a distance; and/or
the reagent container is provided with reinforcing members.

20. The reagent pre-embedding and sample injecting device according to claim 13, wherein:
the outer wall is provided with a notch on each of sides of the hook structure, respectively;
the outer wall is provided with reinforcing members; and/or
the reinforcing members are arranged on at least one side of each notch in an extension direction of the notch.
